(19) United States
(12) Patent Application Publication
(10) Pub. No.: US 2019/0052868 A1
(43) Pub. Date: Feb. 14, 2019

(54) WIDE VIEWING ANGLE VIDEO PROCESSING SYSTEM, WIDE VIEWING ANGLE VIDEO TRANSMITTING AND REPRODUCING METHOD, AND COMPUTER PROGRAM THEREFOR

(71) Applicant: FXGEAR INC., Seoul (KR)

(72) Inventors: Kyung Kun Na, Seoul (KR); Kwang Jin Choi, Seoul (KR)

(21) Appl. No.: 16/078,614

(22) PCT Filed: Feb. 24, 2017
(86) PCT No.: PCT/KR2017/002052

§ 371 Date: Aug. 21, 2018

(30) Foreign Application Priority Data
Feb. 29, 2016 (KR) 10-2016-0024041

(51) Int. Cl. H04N 13/361; G06T 3/40; H04N 13/156; H04N 5/272; H04N 13/194; G06T 7/194

(52) U.S. Cl. CPC H04N 13/361; G06T 3/4038; H04N 13/156; G06T 2207/10016; H04N 13/194; G06T 7/194; G06T 2200/24; H04N 5/272

(57) ABSTRACT

A wide viewing angle video processing system comprises: a transmitting device configured to extract a plurality of background images and one or more foreground videos from an original wide viewing angle video, and to transmit the extracted plurality of background images and one or more foreground videos; and a display device configured to receive the plurality of background images and the one or more foreground videos from the transmitting device, to generate a wide viewing angle background image by combining the plurality of background images, and to generate a reconstructed wide viewing angle video in which the one or more foreground videos are composited on the wide viewing angle background image, and to display the reconstructed wide viewing angle video. The wide viewing angle video processing system can implement a wide viewing angle video having super resolution, which overcomes decoding limitations in conventional virtual reality devices.

### TECHNICAL FIELD

Exemplary embodiments relate to a wide viewing angle video processing system, a wide viewing angle video transmitting and displaying method and a computer program therefore, and more particularly, to technology that after separating and transmitting a foreground and a background in a wide viewing angle video such as a 360-degree panoramic video, enables a display device to reconstruct and display the wide viewing angle video by combining the separated foreground and background.

### BACKGROUND ART

Recently, with the development of various types of video devices, there is a growing demand from users who want to view videos with richer vividness and stereoscopic feelings through video devices. In keeping with this demand, video device providers offer stereoscopic videos by modifying the video content processing mechanism, or provide virtual videos that are too realistic for users to distinguish from real life by connecting various supplemental means to video providing devices. For example, there is technology that provides a user with a feel as if the user really participates in a video environment by simultaneously displaying videos taken at different angles using binocular disparity to provide stereoscopic videos, or by covering the entire visual field of the user with the video to provide videos in panorama format.

FIG. 1 is a conceptual diagram showing the configuration of a panoramic video that is displayed on a conventional virtual reality (VR) device.

As shown in FIG. 1, the VR device 1 is designed in the shape of a head-mounted display that is worn on the head and includes a display designed to cover two eyes of a user. When the display of the VR device 1 has resolution of Quad High Definition (QHD) level, the size of an area 100 seen with an eye of the user through the display of the VR device 1, i.e., W×H, is 1280×1440 pixels. When panorama rendering, assuming that the Field of View (FOV) of a camera is 90 degrees, the 360-degree panoramic video 200 is created by connecting the above-described areas 100, each area being 90 degrees, to cover 360 degrees in the horizontal direction and 180 degrees in the vertical direction on the spherical coordinate system. As a result, when there is no image quality loss, the full size of the 360-degree panoramic video 200 is 10.24 k×2.88 k pixels.

However, most of current commercially available VR devices are designed to make use of mobile devices such as smartphones, and the maximum resolution that can be decoded by hardware acceleration in the VR device is on 4 k level. That is, the maximum size of a panoramic video that can be displayed in the VR device is 4096×2160 pixels. As a result, even though the VR device exerts the maximum performance, the quality of the panoramic video that is actually outputted is under the maximum image quality that the display supports, and there is a limitation of having to endure an image quality loss to some extent.

### DISCLOSURE

### Technical Problem

According to an aspect of the present disclosure, there is provided a wide viewing angle video processing system, a wide viewing angle video transmitting and displaying method and a computer program therefor, in which after separating and transmitting a foreground and a background in a wide viewing angle video such as a 360-degree panoramic video, a display device combines the separated foreground and background to reconstruct and display the wide viewing angle video, thereby increasing the resolution of videos that users see.

### Technical Solution

A wide viewing angle video processing system according to an embodiment includes a transmitting device configured to extract a plurality of background images and one or more foreground videos from an original wide viewing angle video and to transmit the extracted plurality of background images and one or more foreground videos, and a display device configured to receive the plurality of background images and the one or more foreground videos from the transmitting device, to generate a wide viewing angle background image by combining the plurality of background images, and to generate a reconstructed wide viewing angle video in which the one or more foreground videos are composited on the wide viewing angle background image, and to display the reconstructed wide viewing angle video.

A transmitting device according to an embodiment includes an input unit configured to receive a user input that defines an area in which a foreground is disposed in an original wide viewing angle video, a foreground extracting unit configured to extract one or more foreground videos from the original wide viewing angle video based on the user input, a background extracting unit configured to extract a plurality of background images by segmenting an area except the one or more foreground videos from the original wide viewing angle video, and a transmitting unit configured to provide the plurality of background images and the one or more foreground videos to a display device.

In an embodiment, the foreground extracting unit is further configured to extract coordinate information of the one or more foreground videos on a spherical coordinate system corresponding to the original wide viewing angle video.

Additionally, in an embodiment, the transmitting unit is further configured to provide the coordinate information to the display device.

In an embodiment, each of the plurality of background images is an image sequence including a plurality of images arranged in a sequential order, and at least one of bit rate and frame rate of the image sequence is lower than the foreground video.

A wide viewing angle video display device according to an embodiment includes a receiving unit configured to receive a plurality of background images and one or more foreground videos extracted from an original wide viewing angle video, a reconstructing unit configured to generate a wide viewing angle background image by combining the plurality of background images and to generate a reconstructed wide viewing angle video in which the one or more foreground videos are composited on the wide viewing angle background image mapped onto a spherical coordinate system, and a displaying unit configured to display the reconstructed wide viewing angle video.

In an embodiment, the receiving unit is further configured to receive coordinate information of the one or more foreground videos on a spherical coordinate system corresponding to the original wide viewing angle video.

Additionally, in an embodiment, the reconstructing unit is further configured to generate the reconstructed wide viewing angle video in which the one or more foreground videos are composited on position corresponding to the coordinate information.

A wide viewing angle video transmitting method according to an embodiment may be performed using the transmitting device according to the embodiments.

The wide viewing angle video transmitting method according to an embodiment includes receiving a user input that defines an area in which a foreground is disposed in an original wide viewing angle video, extracting one or more foreground videos from the original wide viewing angle video based on the user input, extracting a plurality of background images by segmenting an area except the one or more foreground videos from the original wide viewing angle video, and providing the plurality of background images and the one or more foreground videos to a display device.

In an embodiment, the extracting the one or more foreground videos includes extracting coordinate information of the one or more foreground videos on a spherical coordinate system corresponding to the original wide viewing angle video.

The wide viewing angle video transmitting method according to an embodiment further includes providing the coordinate information to the display device.

In an embodiment, each of the plurality of background images is an image sequence including a plurality of images arranged in a sequential order, and at least one of bit rate and frame rate of the image sequence is lower than the foreground video.

A wide viewing angle video displaying method according to an embodiment may be performed using the display device according to the embodiments.

The wide viewing angle video displaying method according to an embodiment includes receiving a plurality of background images and one or more foreground videos extracted from an original wide viewing angle video, generating a wide viewing angle background image by combining the plurality of background images, generating a reconstructed wide viewing angle video in which the one or more foreground videos are composited on the wide viewing angle background image mapped onto a spherical coordinate system, and displaying the reconstructed wide viewing angle video.

In an embodiment, the receiving includes receiving coordinate information of the one or more foreground videos on a spherical coordinate system corresponding to the original wide viewing angle video.

Additionally, in an embodiment, the generating the reconstructed wide viewing angle video includes generating the reconstructed wide viewing angle video in which the one or more foreground videos are composited on position corresponding to the coordinate information.

A computer program according to embodiments is configured to perform, in combination with hardware, the wide viewing angle video transmitting and displaying method according to the above-described embodiments, and may be recorded on a computer-readable medium.

### Advantageous Effects

According to an aspect of the present disclosure, a background part that is less mobile in original wide viewing angle video data may be segmented into still images of a predetermined size (e.g., 4 k resolution), and when displaying, the still images may be combined to generate a wide viewing angle background image. Meanwhile, after separating a foreground part in original wide viewing angle video data separately, one or more foreground areas may be put together to generate new video data having a size (e.g., 4 k resolution) that can be processed in hardware. As a result, it is possible to implement a wide viewing angle video having super resolution, which overcomes the restriction of 4 k resolution that is the decoding limitation in conventional virtual reality (VR) devices.

### DESCRIPTION OF DRAWINGS

FIG. 1 is a conceptual diagram showing the configuration of a panoramic video that is displayed on a conventional virtual reality device.

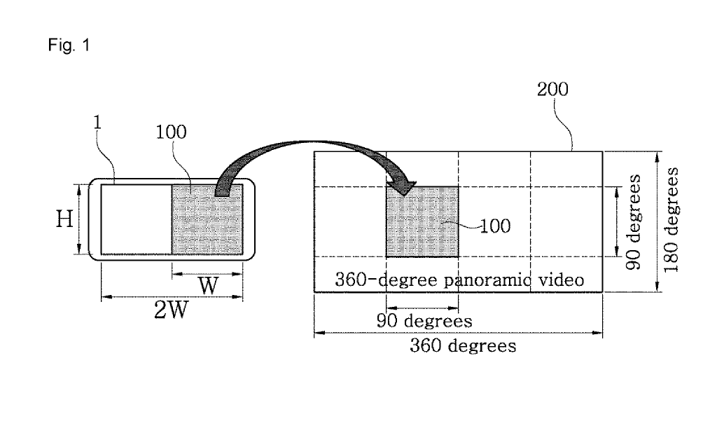

FIG. 2 is a block diagram of a wide viewing angle video processing system according to an embodiment.

FIG. 3 is a conceptual diagram showing an original wide viewing angle video processed by a wide viewing angle video processing method according to an embodiment.

FIG. 4 is a conceptual diagram showing background images and foreground videos extracted from an original wide viewing angle video according to an embodiment.

FIG. 5 is a conceptual diagram showing a wide viewing angle video reconstructed in a display device using background images and foreground videos.

FIG. 6 is a flowchart showing each step of a wide viewing angle video transmitting method according to an embodiment.

FIG. 7 is a flowchart showing each step of a wide viewing angle video displaying method according to an embodiment.

### BEST MODE

Hereinafter, the embodiments of the present disclosure will be described in detail with reference to the accompanying drawings.

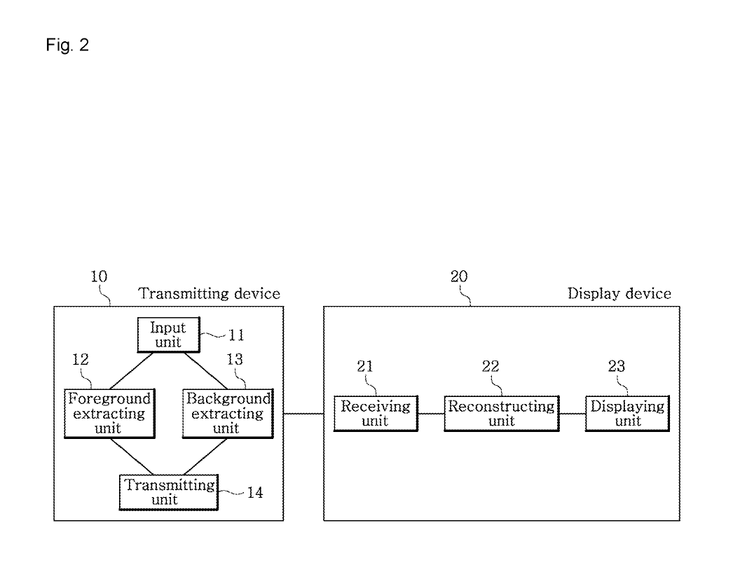

FIG. 2 is a block diagram of a wide viewing angle video processing system according to an embodiment.

Referring to FIG. 2, the wide viewing angle video processing system according to this embodiment includes a transmitting device 10 to process and transmit an original wide viewing angle video, and a display device 20 to receive the processed data and reconstruct and display a wide viewing angle video. In the wide viewing angle video processing system, the display device 20 may be implemented at least in the form of a head-mounted display (HMD) that is worn on the head of a user.

The wide viewing angle video processing system according to the embodiments and each device included therein may have aspects of entirely hardware, or partly hardware and partly software. For example, the wide viewing angle video processing system, each device included therein and each unit that makes up each device may refer collectively to devices for processing, storing and/or transmitting and receiving data of a specific format and content and related software. In the specification, the terms “unit”, “server”, “device”, and “system” are intended to refer to a combination of hardware and software that runs by the corresponding hardware. For example, hardware may be a data processing device including a CPU or any other processor. Additionally, software that runs by hardware may refer to a process being executed, an object, an executable, a thread of execution, a program and the like.

In an embodiment, the transmitting device 10 and the display device 20 are separate devices that are physically different from each other, and they are connected via a wired and/or wireless network to allow them to communicate with each other. Additionally, the network may be a wide area network or a local area network. The transmitting device 10 may transmit data as a result of processing an original wide viewing angle video to the display device 20 via the network, and the display device 20 may receive the processed data, and reconstruct and display the wide viewing angle video to allow the user to see.

However, in another embodiment, the transmitting device 10 and the display device 20 may be incorporated into one device. For example, the transmitting device 10 and the display device 20 may be all embedded in the HMD that is worn on the user's head, and the transmitting device 10 and the display device 20 may be all implemented using one same processing means (e.g., microprocessor) or multiple processing means. Accordingly, although each device 10, 20 and each unit included therein are shown as separate blocks in the block diagram shown in FIG. 2, the system is classified on the basis of the operation performed in the corresponding system, and this is not intended to necessarily indicate separate elements that are physically different from each other.

In an embodiment, the transmitting device 10 includes an input unit 11, a foreground extracting unit 12, a background extracting unit 13 and a transmitting unit 14. The input unit 11 receives an input of an original wide viewing angle video, and receives a user input that defines a foreground in the original wide viewing angle video. To this end, the input unit 11 may include a touchscreen or any other input means. The user may define the foreground area in a manner of defining the position and size of a fixed shape, for example, a square or a rectangle, a circle, and the like, or may define the foreground area by freely defining the contour. Additionally, the input unit 11 may be configured to receive the original wide viewing angle video from another device by a transmission method via the network, but is not limited thereto.

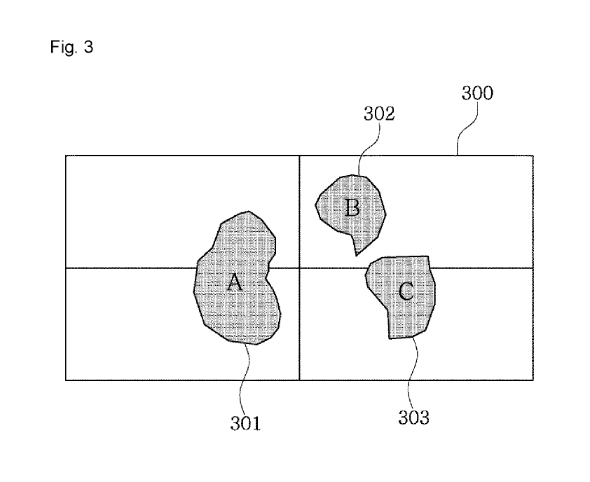

FIG. 3 is a conceptual diagram showing the original wide viewing angle video processed by a wide viewing angle video processing method according to an embodiment.

Referring to FIG. 3, the user may define one or more parts 301, 302, 303 corresponding to the foreground in the original wide viewing angle video 300 while seeing the original wide viewing angle video 300. In the specification, the wide viewing angle video refers to a moving video including a motion at least in part, and the user may define a part intended to preserve the motion in the wide viewing angle video as foreground. In the wide viewing angle video, the remaining area except the foreground may be defined as background. For example, in the case of a video obtained by capturing a figure indoors, the figure part may be defined as foreground, and the remaining part is background.

Referring back to FIG. 2, the foreground extracting unit 12 may extract one or more foreground videos from the original wide viewing angle video based on the user's input. In this instance, the video taken at a wide viewing angle is mapped onto the spherical coordinate system in the form of a texture, and the foreground extracting unit 12 may extract coordinate information in which each foreground video is disposed on the spherical coordinate system together. As the original wide viewing angle video is in the form of a moving video, the coordinate information of the foreground video is not fixed and includes position change information over time.

Meanwhile, the background extracting unit 13 may segment the remaining area except the foreground video in the original wide viewing angle video into a plurality of background images. Each background image may be a still image having no motion, and may have a size (e.g., 4 k resolution) that can be decoded in the display device. As any part of the background may be hidden by the foreground video, the background extracting unit 13 may compare the original wide viewing angle video for each frame, and reconstruct the hidden part in a specific frame using information of one or more other frames to obtain a complete background image with no hidden part.

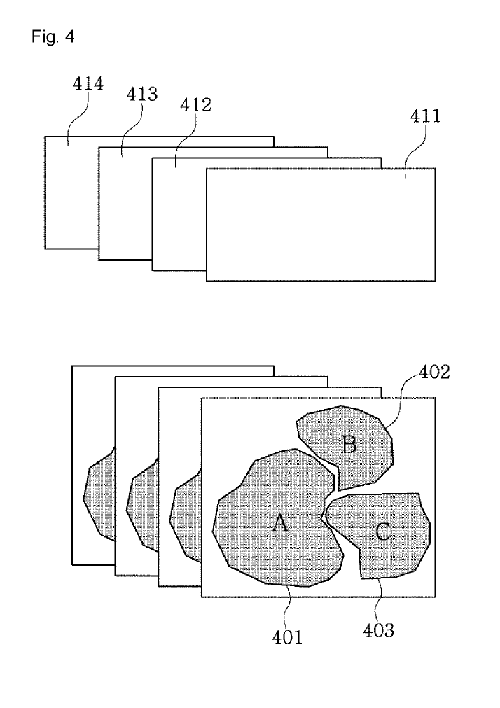

FIG. 4 is a conceptual diagram showing the background images and the foreground videos extracted from the original wide viewing angle video according to an embodiment.

Referring to FIG. 4, one or more foreground videos 401, 402, 403 and a plurality of background images 411, 412, 413, 414 are obtained from the original wide viewing angle video shown in FIG. 3. Although the background part is segmented into four background images having 4 k resolution in the example of FIG. 4, the number of background images is not limited thereto. In the subsequent reconstruction process, the resolution of a reconstructed wide viewing angle video is determined according to the number and arrangement of background images. Meanwhile, one or more foreground videos 401, 402, 403 are moving videos, and include images for each frame, which are arranged in overlay form on the transparent background to create a new moving video. The newly created moving video may have a size (e.g., 4 k resolution) that can be decoded in the display device later.

Referring back to FIG. 2, the transmitting unit 14 may transmit the one or more foreground videos and the plurality of background images generated by the above-described process to the display device 20. Additionally, the transmitting unit 14 may transmit the coordinate information of the foreground video to the display device 20 together. In case that the transmitting device 10 and the display device 20 are separate devices, the transmitting unit 14 may transmit the above-described information by the transmission method via the network. However, in case that the transmitting device 10 and the display device 20 are integrated into a same device, the transmission process by the transmitting unit 14 may represent providing data via a transitory and/or non-transitory memory medium, for example, memory, so that the data can be used in any other processor.

In an embodiment, the display device 20 includes a receiving unit 21, a reconstructing unit 22 and a displaying unit 23. The receiving unit 21 may receive the one or more foreground videos and the plurality of background images from the transmitting unit 14 of the transmitting device 10. As described above with reference to FIG. 4, the one or more foreground videos may be received in the form of a moving video package arranged in overlay form on the transparent background. Additionally, the receiving unit 21 may receive the coordinate information of each foreground video together.

The reconstructing unit 22 reconstructs the wide viewing angle video using the one or more foreground videos and the plurality of background images received by the receiving unit 21. Specifically, the reconstructing unit 22 connects the plurality of background images to generate a wide viewing angle background image. The wide viewing angle background image may be mapped onto the spherical coordinate system in the form of a texture later. Subsequently, the reconstructing unit 22 reconstructs the wide viewing angle video by rendering so that the one or more foreground videos can be composited on the wide viewing angle background image. As described above with reference to FIG. 4, the one or more foreground videos are transmitted in the form of a moving video having resolution that can be decoded in the display device 20, and the reconstructing unit 22 decodes the moving video composed of the foreground videos and maps each foreground video to the corresponding position of the spherical coordinate system using its coordinate information to generate the reconstructed wide viewing angle video.

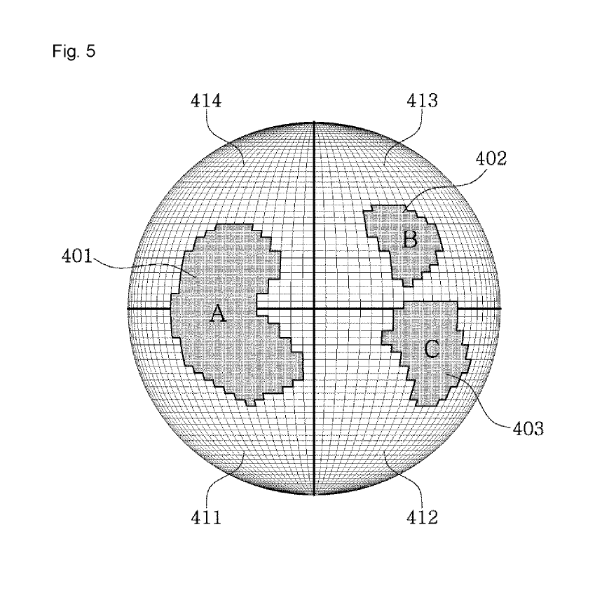

FIG. 5 is a conceptual diagram showing the wide viewing angle video reconstructed in the display device using the background images and the foreground videos.

Referring to FIG. 5, four background images 411, 412, 413, 414 having 4 k resolution are combined in the spherical coordinate system, and foreground videos 401, 402, 403 are arranged on the spherical coordinate system to create a super resolution wide viewing angle video. Accordingly, according to this embodiment, there are advantages of overcoming the decoding limitation in the conventional virtual reality device, in general, the restriction of 4 k, and implement a super resolution wide viewing angle video having higher resolution, for example, 11 k.

In the above-described embodiments, the transmitting device 10 creates the background image in the form of a fixed image. However, in another embodiment, a series of images (or image sequence) including each background image arranged in a sequential order may be included. However, if the background image is created in the form of a complete moving video like the foreground video, the decoding limitation of the display device 20 will be over, and thus, in this case, the image sequence that forms the background image needs to have at least a lower bit rate and/or frame rate than the foreground video.

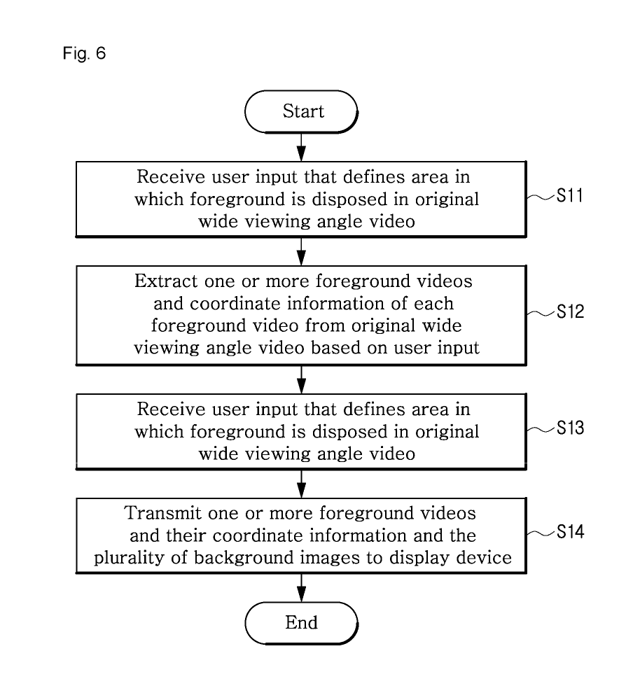

FIG. 6 is a flowchart showing each step of a wide viewing angle video transmitting method according to an embodiment. For example, the wide viewing angle video transmitting method shown in FIG. 6 may be performed using the transmitting device 10 of the embodiment described above with reference to FIGS. 2 to 5.

Referring to FIG. 6, first, a user input that defines a foreground in an original wide viewing angle video may be received (S11). Subsequently, one or more foreground videos may be extracted from the original wide viewing angle video based on the received user input (S12). In this instance, coordinate information in which each foreground video is disposed on the spherical coordinate system corresponding to the original wide viewing angle video may be also extracted.

Subsequently, a plurality of background images may be extracted by segmenting an area except the foreground video in the original wide viewing angle video (S13). Each background image may have a size (e.g., 4 k resolution) that can be decoded in the display device later. Where any part of the background is hidden by the foreground video, a complete background image may be obtained by comparing the original wide viewing angle video for each frame and reconstructing the hidden part in a specific frame using information of one or more other frames. Each background image may be a fixed image, but according to embodiments, each background image may be an image sequence having a lower bit rate and/or frame rate than the foreground video.

Subsequently, the one or more foreground videos and the plurality of background images may be transmitted to the display device (S14). In this instance, the one or more foreground videos may be arranged in overlay form on the transparent background and may be created and transmitted in the form of a moving video having a size (e.g., 4 k resolution) that can be decoded in the display device. Additionally, the coordinate information of each foreground video on the spherical coordinate system may be transmitted to the display device together.

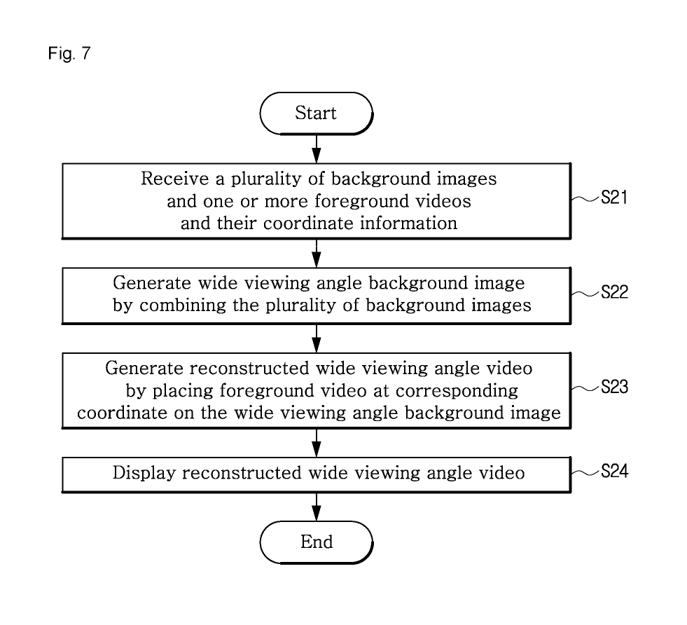

FIG. 7 is a flowchart showing each step of a wide viewing angle video displaying method according to an embodiment. For example, the wide viewing angle video displaying method shown in FIG. 7 may be performed using the display device 20 of the embodiment described above with reference to FIGS. 2 to 5.

Referring to FIG. 7, first, a plurality of background images and one or more foreground videos may be received (S21). The one or more foreground videos may be arranged in overlay form on the transparent background and may be received in the form of a moving video having a size (e.g., 4 k resolution) that can be decoded in the display device. In this instance, coordinate information in which each foreground video will be disposed on the spherical coordinate system may be received together.

Subsequently, a wide viewing angle background image may be generated by combining the plurality of background images (S22). The background image may be a fixed image, but according to embodiments, the background image may be an image sequence having a low bit rate and/or frame rate, and in this case, the wide viewing angle background image generated from the background images may be also an image sequence.

Subsequently, a wide viewing angle video may be reconstructed by arranging the one or more foreground videos on the wide viewing angle background image (S23). This represents mapping the above-described wide viewing angle background image onto the spherical coordinate system and rendering the reconstructed wide viewing angle video in which the one or more foreground videos are composited thereon in overlay form. In this instance, as the display device can receive the coordinate information on the spherical coordinate system of each foreground video, it is possible to generate the reconstructed wide viewing angle video in which each foreground video is disposed at the same position as original using the corresponding coordinate information.

Finally, the reconstructed wide viewing angle video may be displayed so that the user can see it (S24). This refers to displaying the wide viewing angle video on display means that is integrated in the display device or designed to receive video data from the display device. Through the above-described process, it is possible to overcome the resolution restriction caused by the decoding limitation as in the conventional device, and allow the user to see the wide viewing angle video having super resolution of 11 k.

The wide viewing angle video transmitting and displaying methods according to the above-described embodiments may be implemented as a computer program at least in part, and recorded on computer-readable recording media. The computer-readable recording media includes any type of recording device in which computer-readable data is stored. Examples of the computer-readable recording media include ROM, RAM, CD-ROM, magnetic tape, floppy disk, and optical data storing devices. Additionally, the computer-readable recording media is distributed over computer systems connected via a network so that computer-readable codes may be stored and executed in distributed manner. Additionally, functional programs, codes and code segments for realizing this embodiment will be easily understood by those having ordinary skill in the technical field to which this embodiment belongs.

The present disclosure has been hereinabove described with reference to the embodiments disclosed in the drawings, but this is provided for illustration only and those having ordinary skill in the art will understand that various modification and variations may be made thereto. However, it should be noted that such modifications fall within the scope of technical protection of the present disclosure. Accordingly, the true scope of technical protection of the present disclosure should be defined by the technical spirit of the appended claims.

### INDUSTRIAL APPLICABILITY

Exemplary embodiments relate to a wide viewing angle video processing system, a wide viewing angle video transmitting and displaying method and a computer program therefor, and more particularly, to technology that after separating and transmitting a foreground and a background in a wide viewing angle video such as a 360-degree panoramic video, enables a display device to reconstruct and display the wide viewing angle video by combining the separated foreground and background.

1. A wide viewing angle video processing system, comprising:
a transmitting device configured to extract a plurality of background images and one or more foreground videos from an original wide viewing angle video, and to transmit the extracted plurality of background images and one or more foreground videos; and
a display device configured to receive the plurality of background images and the one or more foreground videos from the transmitting device, to generate a wide viewing angle background image by combining the plurality of background images, and to generate a reconstructed wide viewing angle video in which the one or more foreground videos are composited on the wide viewing angle background image, and to display the reconstructed wide viewing angle video.

2. The wide viewing angle video processing system according to claim 1, wherein the transmitting device is further configured to extract coordinate information of the one or more foreground videos on a spherical coordinate system corresponding to the original wide viewing angle video, and
the display device is further configured to receive the coordinate information from the transmitting device, and to generate the reconstructed wide viewing angle video in which the one or more foreground videos are composited on position corresponding to the coordinate information in the wide viewing angle background image mapped onto the spherical coordinate system.

3. The wide viewing angle video processing system according to claim 1, wherein each of the plurality of background images is an image sequence including a plurality of images arranged in a sequential order, and at least one of bit rate and frame rate of the image sequence is lower than the foreground video.

4. A wide viewing angle video transmitting device, comprising:
an input unit configured to receive a user input that defines an area in which a foreground is disposed in an original wide viewing angle video;
a foreground extracting unit configured to extract one or more foreground videos from the original wide viewing angle video based on the user input;
a background extracting unit configured to extract a plurality of background images by segmenting an area except the one or more foreground videos from the original wide viewing angle video; and
a transmitting unit configured to provide the plurality of background images and the one or more foreground videos to a display device.

5. The wide viewing angle video transmitting device according to claim 4, wherein the foreground extracting unit is further configured to extract coordinate information of the one or more foreground videos on a spherical coordinate system corresponding to the original wide viewing angle video, and
the transmitting unit is further configured to provide the coordinate information to the display device.

6. The wide viewing angle video transmitting device according to claim 4, wherein each of the plurality of background images is an image sequence including a plurality of images arranged in a sequential order, and at least one of bit rate and frame rate of the image sequence is lower than the foreground video.

7. A wide viewing angle video display device, comprising:
a receiving unit configured to receive a plurality of background images and one or more foreground videos extracted from an original wide viewing angle video;
a reconstructing unit configured to generate a wide viewing angle background image by combining the plurality of background images, and to generate a reconstructed wide viewing angle video in which the one or more foreground videos are composited on the wide viewing angle background image mapped onto a spherical coordinate system; and
a displaying unit configured to display the reconstructed wide viewing angle video.

8. The wide viewing angle video display device according to claim 7, wherein the receiving unit is further configured to receive coordinate information of the one or more foreground videos on a spherical coordinate system corresponding to the original wide viewing angle video, and
the reconstructing unit is further configured to generate the reconstructed wide viewing angle video in which the one or more foreground videos are composited on position corresponding to the coordinate information.

9. A wide viewing angle video transmitting method, comprising:
receiving, by a transmitting device, a user input that defines an area in which a foreground is disposed in an original wide viewing angle video;
extracting, the transmitting device, one or more foreground videos from the original wide viewing angle video based on the user input;
extracting, by the transmitting device, a plurality of background images by segmenting an area except the one or more foreground videos from the original wide viewing angle video; and
providing, by the transmitting device, the plurality of background images and the one or more foreground videos to a display device.

10. The wide viewing angle video transmitting method according to claim 9, wherein the extracting the one or more foreground videos comprises extracting coordinate information of the one or more foreground videos on a spherical coordinate system corresponding to the original wide viewing angle video, and
the wide viewing angle video transmitting method further comprises providing the coordinate information to the display device.

11. The wide viewing angle video transmitting method according to claim 9, wherein each of the plurality of background images is an image sequence including a plurality of images arranged in a sequential order, and at least one of bit rate and frame rate of the image sequence is lower than the foreground video.

12. A wide viewing angle video displaying method, comprising:
receiving, by a display device, a plurality of background images and one or more foreground videos extracted from an original wide viewing angle video;
generating, by the display device, a wide viewing angle background image by combining the plurality of background images;
generating, by the display device, a reconstructed wide viewing angle video in which the one or more foreground videos are composited on the wide viewing angle background image mapped onto a spherical coordinate system; and
displaying the reconstructed wide viewing angle video on the display device.

13. The wide viewing angle video displaying method according to claim 12, wherein the receiving comprises receiving coordinate information of the one or more foreground videos on a spherical coordinate system corresponding to the original wide viewing angle video, and
the generating the reconstructed wide viewing angle video comprises generating the reconstructed wide viewing angle video in which the one or more foreground videos are composited on position corresponding to the coordinate information.

14. A computer program stored in a computer-readable medium to perform, in combination with hardware, the steps of:
receiving a user input that defines an area in which a foreground is disposed in an original wide viewing angle video;
extracting one or more foreground videos from the original wide viewing angle video based on the user input;
extracting a plurality of background images by segmenting an area except the one or more foreground videos from the original wide viewing angle video; and
providing the plurality of background images and the one or more foreground videos to a display device.

15. A computer program stored in a computer-readable medium to perform, in combination with hardware, the steps of:
receiving a plurality of background images and one or more foreground video extracted from an original wide viewing angle video;
generating a wide viewing angle background image by combining the plurality of background images;
generating a reconstructed wide viewing angle video in which the one or more foreground videos are composited on the wide viewing angle background image mapped onto a spherical coordinate system; and
displaying the reconstructed wide viewing angle video.
